(19) United States
(12) Patent Application Publication
(10) Pub. No.: US 2021/0215226 A1
(43) Pub. Date: Jul. 15, 2021

(54) TORSIONAL VIBRATION DAMPER

(71) Applicant: AUDI AG, Ingolstadt (DE)

(72) Inventor: Michael BUCK, Ingolstadt (DE)

(73) Assignee: AUDI AG, Ingolstadt (DE)

(21) Appl. No.: 17/056,119

(22) PCT Filed: Jun. 4, 2019
(86) PCT No.: PCT/EP2019/064520

§ 371 Date: Nov. 17, 2020

(30) Foreign Application Priority Data
Jul. 3, 2018 (DE) 10 2018 210 945.1

(51) Int. Cl. F16F 15/134; F16F 15/131; F16F 15/16

(52) U.S. Cl. CPC F16F 15/134; F16C 2361/55; F16F 15/165; F16F 15/13171

(57) ABSTRACT

A torsional vibration damper in the form of a two-mass flywheel for a motor vehicle, the dual-mass flywheel having a primary mass that is connected to the drive shaft of a drive engine in a torsionally rigid manner and revolves therewith, at least one energy storage element, and a secondary mass which is driven in a torsionally flexible manner by the primary mass via the energy storage element. The torque fed into the primary mass via the drive shaft is transmitted to at least one further link of the motor vehicle drive train arranged in a housing via an output shaft of the secondary mass. The primary mass is designed as a rotationally symmetrical hollow body that is concentric to its axis of rotation, open at least on one side, surrounds the secondary mass.

### DESCRIPTION

The invention relates to a torsional vibration damper for a motor vehicle according to the preamble of claim 1.

In motor vehicles with internal combustion engines, in particular four-stroke reciprocating engines, the four strokes that are performed periodically in connection with the firing sequence cause rotational irregularities on the engine shaft. Since the drive train is a system that can develop torsional vibrations, the rotational irregularities cause it to vibrate, which leads to gear rattle, especially when running at resonance-critical speeds, and to uncomfortable acoustic effects due to the connection of the drive train to the body. Typically, torsional vibration dampers with a dual-mass flywheel are used today, as known, for example, from DE 41 17 582 A1, in order to mitigate such rotational irregularities. A dual-mass flywheel of the type mentioned typically has a primary flywheel mass (engine side) and a secondary flywheel mass (gearbox side), which are connected to one another in a torsionally flexible manner by means of arc springs.

Typically, torsional vibration dampers of the type described above are arranged between the internal combustion engine and the gearbox, wherein the installation space in which the torsional vibration damper is arranged is referred to as gearbox bell housing. This is a bell-shaped attachment on the gearbox housing via which the gearbox is flanged to the internal combustion engine near the engine shaft. Typically, the gearbox bell housing is not sealed off from its surroundings but has openings for assembly purposes and the penetration of the starter pinion, such that the torsional vibration damper comes into contact with water and dust, which can, in particular, enter the area of the arc spring and negatively affect functioning and service life of the torsional vibration damper.

In order to prevent this, it is already known from DE 10 2014 209 902 A1, to provide a sealing assembly comprising at least one disc spring between the primary mass and the secondary mass in a dual-mass flywheel with a primary mass and a secondary mass which can be rotated relative to one another against the force of a spring assembly.

A torsional vibration damper of a similar type is also described in DE 10 2013 205 919 A. A torsional vibration damper in the form of a dual-mass flywheel for a wet-friction clutch of a motor vehicle is proposed therein, the dual-mass flywheel having a primary mass that is connected to the drive shaft of a drive engine in a torsionally rigid manner and revolves therewith, at least one energy storage element and a secondary mass which is driven in a torsionally flexible manner by the primary mass via the energy storage element. The torque fed into the primary mass via the drive shaft is transmitted to at least one further link of the motor vehicle drive train arranged in a housing via an output shaft of the secondary mass. It is also provided that the primary mass is designed as a rotationally symmetrical hollow body that is open at least on one side concentrically to its axis of rotation and surrounds the secondary mass, and that the open side of the hollow body is penetrated by the output shaft of the secondary mass that is rotatably supported in the housing. Sealing elements between the primary mass and the secondary mass are proposed to seal the energy storage element arranged in a receiving channel of the hollow body.

Both sealing measures have in common that they provide a seal between the primary mass and the secondary mass, which inevitably means that the primary mass and the secondary mass must be in sliding contact with one another in order to achieve the intended seal, in particular of the space for the energy storage element, for example the arc springs, against dust and/or liquids. However, such a sliding contact between the primary mass and the secondary mass affects the vibration behavior of the torsional vibration damper in an unwanted manner.

It is therefore the object of the invention to provide a torsional vibration damper that achieves a seal, in particular of the space in which the energy storage element is located, against dust and/or liquids without affecting the vibration characteristics of the torsional vibration damper while preventing the above-mentioned disadvantages of the prior art.

This object is achieved by an assembly according to claim 1, advantageous embodiments and developments of the torsional vibration damper are characterized in the dependent claims.

A torsional vibration damper in the form of a two-mass flywheel for a motor vehicle is proposed, the dual-mass flywheel having a primary mass that is connected to the drive shaft of a drive engine in a torsionally rigid manner and revolves therewith, at least one energy storage element and a secondary mass which is driven in a torsionally flexible manner by the primary mass via the energy storage element. The torque fed into the primary mass via the drive shaft is transmitted to at least one further link of the motor vehicle drive train arranged in a housing via an output shaft of the secondary mass. Furthermore, the primary mass is designed as a rotationally symmetrical hollow body that is open at least on one side concentrically to its axis of rotation and surrounds the secondary mass, and the open side of the hollow body is penetrated by the output shaft of the secondary mass that is rotatably supported in the housing. To seal the hollow body forming the primary mass against dust and/or liquids it is rotatably supported by means of a sealing assembly sealing its open side in a liquid- and/or dust-tight manner.

Since the seal is not provided between the primary mass and the secondary mass, but between the primary mass and the adjacent housing, advantageously, the vibration behavior of the secondary mass relative to the primary mass is not affected such that the damping characteristics of the torsional vibration damper remain always the same.

To improve the mountability of the secondary mass within the hollow body forming the primary mass, it is advantageous if the hollow body forming the primary mass is composed of at least two parts. Of course, the hollow body forming the primary mass can also consist of more than two parts. The individual parts can be detachably connected, for example by screwing, or undetachably connected, for example by welding.

To achieve an exact alignment of the torsional vibration damper relative to the housing, it is advantageous to connect the housing to the drive engine housing such that they are fixed to the frame. It is further advantageous if the housing with the at least one link of the drive train arranged therein is the gearbox housing, as is usual with drive engine-gearbox combinations in motor vehicles, and if the connection to the housing of the drive engine is formed by a bell-shaped attachment arranged on the gearbox housing and the bell-shaped attachment is, optionally using centering means, screwed to the housing of the drive engine.

It is known to arrange centrifugal pendulums on the secondary mass to improve the damping properties of torsional vibration dampers. In this case it is advantageous to enclose the centrifugal pendulum together with the secondary mass in the hollow body formed by the primary mass such that these moving elements are protected from the influences of dust and/or liquids as well.

In embodiments of the torsional vibration damper according to the invention, it is advantageous to form the seal between the hollow body forming the primary mass and the housing by an elastically deformable friction ring. This eliminates the need for the hollow body to be rotatably supported on the wall of the housing, it is rather sufficient for the friction ring to be in frictional connection with the hollow body and/or with the wall of the housing. Advantageously, the material used for the friction ring is an elastic material having a corresponding abrasion resistance. Of course, the frictional connection can be designed as a low-friction connection by means of a lubricant.

It is advantageous to provide a pivot bearing assembly between the hollow body forming the primary mass and the housing to ensure a secure sealing effect of the sealing assembly even with transverse forces acting on the primary mass. Thus, the primary mass is additionally guided, as a result of which the hollow body itself and the bearings of the drive engine are relieved of load when transverse forces are acting on the primary mass. If the pivot bearing assembly is a sealing pivot bearing, this simultaneously assumes the function of the sealing assembly.

Advantageously, a sliding pivot bearing with two degrees of freedom can be used as pivot bearing. Such a sliding pivot bearing is able both to assume the sealing function and to compensate for tolerances between the hollow body and the wall of the housing in the axial direction.

Of course, there is also the possibility of using a dust- and/or liquid-tight roller bearing with one degree of freedom as the pivot bearing.

If a pivot bearing is provided between the hollow body and the wall, it may be necessary to compensate for any offset that may exist between the axis of rotation of the primary mass and the central axis of the receptacle for the primary mass on the wall of the housing. Advantageously, a device that compensates for the axial offset is to be provided for this purpose. For example, this can be a bearing receptacle on the wall of the housing that is adjustable in the area perpendicular to the axis of rotation of the primary mass.

Further embodiments and advantages of the invention are explained in more detail below with reference to the drawings. In which:

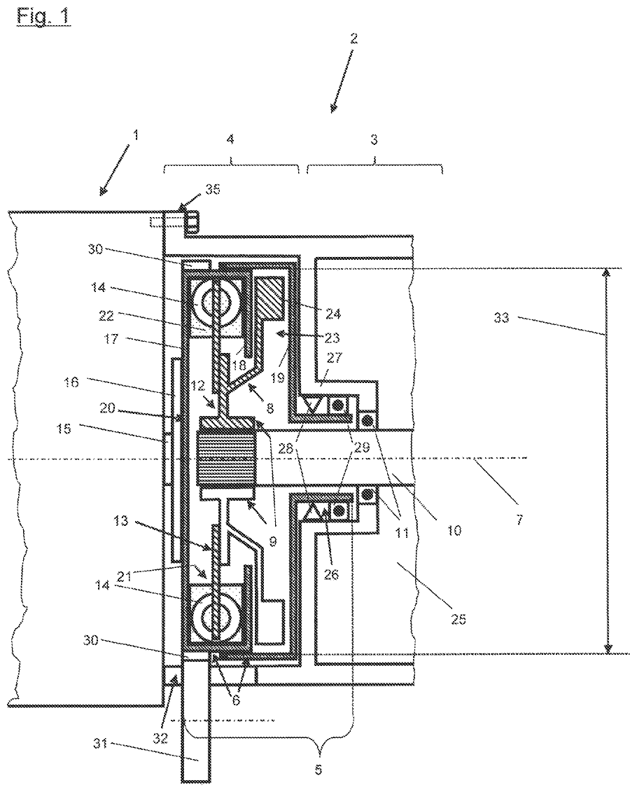

FIG. 1 shows a schematic representation of a drive train of a motor vehicle (partial representation) with sealed torsional vibration damper;

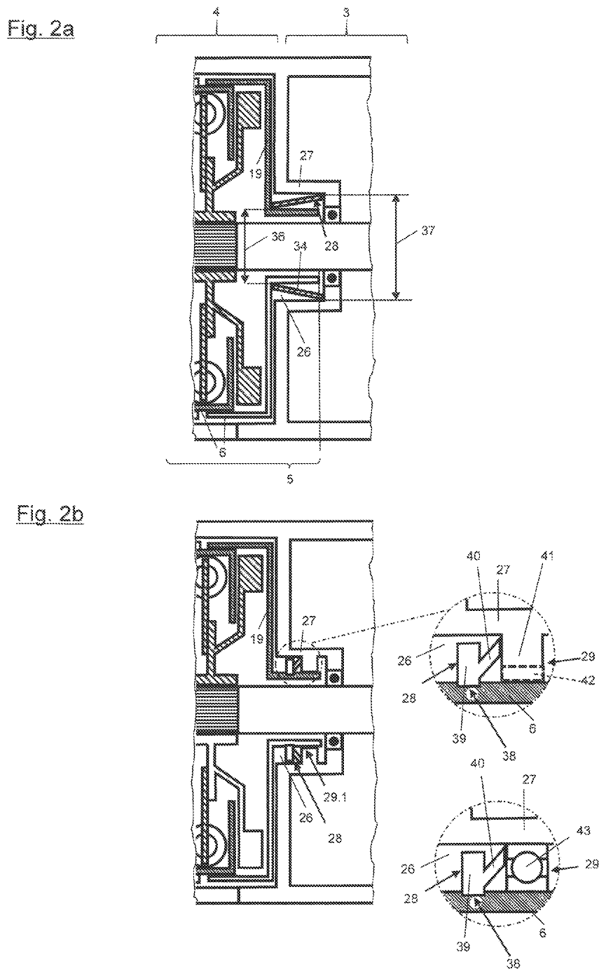

FIG. 2a shows a partial representation of the assembly in FIG. 1 with the torsional vibration damper being sealed in a first embodiment;

FIG. 2b shows a partial representation of the assembly in FIG. 1 with the torsional vibration damper being sealed in a second embodiment and the primary mass being supported on the gearbox housing;

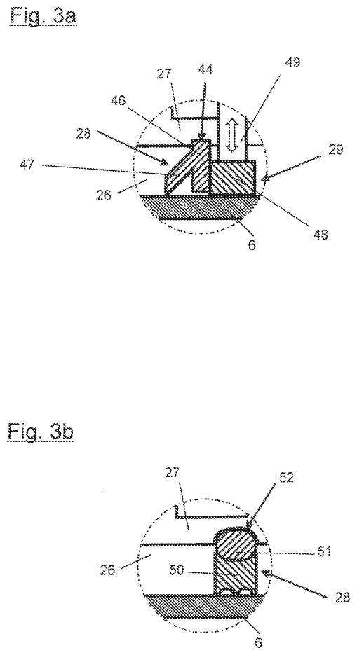

FIG. 3a shows a schematic representation of a seal and support in a third embodiment (partial representation);

FIG. 3b shows a schematic representation of a seal and support in a fourth embodiment (partial representation).

FIG. 1 shows a simplified partial representation of a drive train of a motor vehicle (not shown), consisting of a drive engine 1 (partial representation) and a gearbox 2 (partial representation). The gearbox 2 is shown in section and consists of the (actual) gearbox housing 3 and a bell-shaped attachment 4, which is usually referred to as the gearbox bell housing, on the housing side. The bell-shaped attachment 4 of the gearbox housing 3 is fixed to the drive engine by means of corresponding screw connections 35 such that they are fixed to the frame. The gearbox 2 can be both a conventional manual gearbox and an automatically engaging double-clutch gearbox. The clutches and gear stages arranged in the gearbox housing 3 are not shown because they are not pertinent in the context to be considered here. A rotary vibration damper 5, shown in section along its axis of rotation 7, is arranged between the drive engine 1 and the gearbox housing 3 in the bell-shaped attachment 4. The latter consists of a primary mass 6 designed as a rotationally symmetrical hollow body and a plate-shaped secondary mass 8. The engine torque of the drive engine is introduced into the vibration damper via the engine shaft 15 and a flange 16 which is arranged thereon in a torsionally rigid manner and which is connected to the primary mass 6 in a torsionally fixed manner Primary mass 6 and secondary mass 8 are coupled by arc springs 14 supported on primary mass 6 in a torsionally flexible manner by means of arms 13 that are arranged on the plate base 12 of the plate-shaped secondary mass 8 such as to be fixed to the frame acting on the ends of the arc springs 14 that are not supported on primary mass 6. The plate base 12 of the plate-shaped secondary mass 8 has a sleeve-shaped, toothed recess 9 which is engaged by a toothed output shaft 10 engages in a torsionally fixed manner The output shaft 10 is supported by means of a bearing 11 in the gearbox housing 3 and transfers the torque to a following link (not shown) of the drive train arranged in the gearbox housing.

As can be seen in the sectional view of the torsional vibration damper 5 in FIG. 1, the primary mass 6, which is embodied as a rotationally symmetrical hollow body, consists of two parts, a cup-shaped first part 17 with an inverted cup rim 18 and a second part 19 that is arranged on the outer circumference of the first part 17 on the side with the inverted cup rim 18 and formed in the manner of a stepped tube.

The cup-shaped first part 17 is connected to the cup base 20 via the flange 16, preferably by screw connections (not shown) and, forms a receiving channel 21 for the arc springs 14 by means of the inverted cup rim 18. The receiving channel 21 is filled with lubricating grease 22 surrounding the arc springs 14. A starter ring gear 30 is arranged on the outer circumference of the cup-shaped first part 17 which meshes with a starter pinion 31 of a starter (not shown). The starter pinion 31 is operatively connected with the starter ring gear 30 via an opening 32 in the bell-shaped attachment 4 on the gearbox housing 3, so that the interior of the bell-shaped attachment 4 is connected to the environment and is thus directly exposed to dust and liquids.

The second part 19, the large inner diameter 33 of which is arranged on the outer circumference of the first part 17, is welded to the first part 17, so that a space 23 is formed between the inverted cup rim 18 and the wall of the second part 19 extending radially inward. The thickened rim of the plate-shaped secondary mass 8 forming the flywheel mass 24 is arranged in the space 23. Contrary to the example shown, centrifugal pendulums (not shown) can be arranged on the flywheel mass 24, as is known per se, to increase the damping effect of the torsional vibration damper. As already mentioned above, the secondary mass 8 can be rotated relative to the primary mass 6 within the range of the spring travel defined by the arc spring 14. The part of the stepped tube having the small tube diameter adjoins the wall extending radially inward of the second part 19 of the primary mass 6, which is designed as a stepped tube. This protrudes into a recess 26 which is arranged concentrically to the axis of rotation 7 and which is formed in the housing wall 27 separating the space in the bell-shaped attachment 4 from the interior 25 of the gearbox housing 3. In the area of the recess 26, the housing wall 27 and the free end of the second part 19 of the primary mass 6 extend concentrically parallel to each another, at a constant distance from one another. In this area, a sealing assembly 28 is arranged between the housing wall 27 and the free end of the second part 19 of the primary mass 6, which seals the interior of the hollow body forming the primary mass 6 and thus the interior of the torsional vibration damper 5 against the environment. In this way, dust and/or liquids that has/have penetrated the bell-shaped attachment 4 on the gearbox housing 3 via the opening 32 can be kept away from the interior of the torsional vibration damper 5 without affecting the vibration behavior between the primary mass 6 and secondary mass 8. Additional measures may be necessary to prevent lateral forces, for example, caused when off-road vehicles drive over uneven ground, from overly stressing or, in extreme cases, even deforming the material of the primary mass 6, which is designed as a hollow body. In the chosen example, a pivot bearing assembly 29 is provided in the area between the housing wall 27 and the free end of the second part 19 of the primary mass 6, so that any lateral forces are dissipated by the housing wall 27. This pivot bearing assembly 29 does not affect the vibration behavior of the torsional vibration damper 5 either. If the pivot bearing assembly 29 is a sealed bearing, it also assumes the function of the sealing assembly 28.

There are various possibilities for implementing the sealing assembly 28 and optionally a pivot bearing assembly 29 to achieve the desired sealing effect and, if necessary, support the primary mass 6 on the housing wall 27, some of which are described below in connection with FIGS. 2a to 3b.

A particularly simple possibility is shown in FIG. 2a. A simplified partial representation corresponding to the representation in FIG. 1 shows the gearbox housing 3 with the bell-shaped attachment 4 arranged thereon, as well as the torsional vibration damper 5 arranged in the bell-shaped attachment 4. The only difference exists with regard to the sealing assembly; a pivot bearing of the primary mass 6 on the housing wall 27 is not provided. Since the structure of the torsional vibration damper 5 itself does not differ from the embodiment according to FIG. 1, the description is not repeated and reference is made instead to the above description of FIG. 1. Only the deviations from the example according to FIG. 1 are described hereinafter.

The sealing assembly 28 according to FIG. 2a consists of a funnel-shaped friction ring 34, the small inner diameter 36 of which is arranged on the free end of the second part 19 of the primary mass 6 in press fit. The large outer diameter 37 of the friction ring 34, which is designed to be self-springing, is in frictional contact with the inner diameter of the recess 26.

Deviating from the representation in FIG. 2a, the recess 26, which is arranged concentrically to the axis of rotation 7 and is formed in the housing wall 27, can be funnel-shaped such that the inner diameter decreases with increasing depth of the recess 26. On the one hand, this improves the mountability, and on the other hand, an axial offset between the axis of rotation 7 of the primary mass 6 and the central axis of the recess 26 caused by tolerances can be compensated for without affecting the sealing effect.

Another possible embodiment of a sealing assembly 28 in connection with a pivot bearing assembly 29 is shown in FIG. 2b. The representation on the left in the drawing again shows, as in FIG. 1, a simplified partial representation of the gearbox housing 3 with the bell-shaped attachment 4 arranged thereon, as well as the torsional vibration damper 5 arranged in the bell-shaped attachment 4. Again, to avoid repetition, the description of the torsional vibration damper 5 is not repeated and reference is made instead to the corresponding parts of the description relating to FIG. 1. The sealing assembly 28 and the pivot bearing assembly 29 are only roughly indicated in this representation, their structure is evident from the detailed representation at the top right showing an enlargement of area marked correspondingly in the representation on the left. From this enlarged representation it can be seen that an annular seal carrier 39 is arranged in a circumferential groove 38 at the free end of the second part 19 of the primary mass 6, which surrounds the free end of the second part 19 of the primary mass 6 under pretension. A sealing shoulder 40, which extends obliquely outwards and is designed as a friction seal, is arranged on the seal carrier 39. This sealing shoulder 40 is in frictional operative connection with a bearing ring 41 formed on the housing wall 27 and protruding into the recess 26 and thus seals the interior of the torsional vibration damper against dust and fluids. The bearing ring 41 is used to support the free end of the second part 19 of the primary mass 6 on the housing wall 27. To minimize friction at the bearing point, a self-lubricating ring 42 can be arranged between the bearing ring 41 and the free end of the second part 19 of the primary mass 6.

The bottom right representation in FIG. 2b shows an embodiment that is slightly different from the embodiment described above. The sealing assembly 28 is identical herein, only the bearing ring 41 is replaced by a roller bearing 43, which is arranged between the free end of the second part 19 of the primary mass 6 and the housing wall 27.

Further variants of embodiments of a sealing assembly 28 in connection with a pivot bearing assembly 29 can be seen in FIGS. 3a and 3b. Since the only change is in the sealing assembly 28 and the pivot bearing assembly 29 compared to the examples described above, the representations in FIGS. 3a and 3b are limited to detail representations similar to the detail representations shown on the right in FIG. 2b.

From the representation according to FIG. 3a it can be seen that a groove 44 in the housing wall 27 surrounding the free end of the second part 19 of the primary mass 6, extends in an annular manner. A shaft seal is arranged in this groove 44 as a sealing assembly 28 consisting of a carrier 46 mounted in the groove 44 under pretension and a sealing attachment 47 arranged thereon. The latter extends obliquely inwards from the carrier 46 towards the free end of the second part 19 of the primary mass 6 and rests against it under pretension. Furthermore, a bearing ring 48 is provided as the pivot bearing assembly 29, which can be adjusted via adjustment devices 49 in a plane perpendicular to the axis of rotation 7 (FIG. 1) of the primary mass 6. The purpose of the adjustment devices 49 is to compensate for any deviations between the axis of rotation 7 of the primary mass 6 and the central axis of the recess 26. The carrier 46 is supported on the bearing ring 48 with its free end in the axial direction.

FIG. 3b shows a schematic representation of another sealing option. A sealing assembly 28 is provided therein consisting of a shaft sealing ring 50 and a pretensioning element 51 in the form of an O-ring extending circumferentially around the shaft seal 50. A groove 52 is provided for support which extends around the housing wall 27 in the area of the free end of the second part 19 of the primary mass 6 in an annular manner The combination of shaft seal 50 and pretensioning element 51 is maintained pretensioned in groove 52 and is in sliding contact with primary mass 6. With an appropriate design, this combination of shaft seal 50 and pretensioning element 51 can assume both bearing tasks and provide compensation for an offset between the axis of rotation 7 of the primary mass 6 and the central axis of the recess 26.

It can be seen from the various possible embodiments of a sealing assembly and, optionally, a rotary bearing assembly between primary mass and gearbox housing described above as an example that generally all known shaft seals can be contemplated for sealing and all known pivot bearing assemblies can be contemplated for supporting.

1-10. (canceled)

11. A torsional vibration damper in the form of a two-mass flywheel for a motor vehicle, comprising: a primary mass hat is connected to a drive shaft of a drive engine in a torsionally rigid manner and revolves therewith, at least one energy storage element, and a secondary mass which is driven in a torsionally flexible manner by the primary mass via the energy storage element, wherein the torque fed into the primary mass via the drive shaft is transmitted to at least one further link of the motor vehicle drive train arranged in a housing via an output shaft of the secondary mass, wherein the primary mass is a rotationally symmetrical hollow body that is open at least on one side concentrically to its axis of rotation and surrounds the secondary mass, and the open side of the hollow body is penetrated by the output shaft of the secondary mass, wherein the output shaft of the secondary mass is rotatably supported in the housing, wherein the hollow body forming the primary mass is rotatably supported on the housing by a sealing assembly sealing its open side in a liquid- and/or dust-tight manner

12. The torsional vibration damper according to claim 11, wherein the hollow body forming the primary mass is composed of at least two parts.

13. The torsional vibration damper according to claim 11, wherein the housing is connected to the housing of the drive engine such that they are fixed to the frame.

14. The torsional vibration damper according to claim 13, wherein the housing is the gearbox housing of the motor vehicle and the connection to the housing of the drive engine is formed by a bell-shaped attachment arranged on the gearbox housing and the bell-shaped attachment is screwed to the housing of the drive engine.

15. The torsional vibration damper according to claim 11, wherein centrifugal force pendulums are arranged on the secondary mass and are enclosed together therewith by the hollow body forming the primary mass.

16. The torsional vibration damper according to claim 11, wherein the sealing assembly between the hollow body forming the primary mass and the housing is formed by an elastically deformable friction ring.

17. The torsional vibration damper according to claim 11, wherein a pivot bearing assembly is arranged between the hollow body forming the primary mass and the housing.

18. The torsional vibration damper according to claim 17, wherein the pivot bearing assembly is a sliding pivot bearing with two degrees of freedom.

19. The torsional vibration damper according to claim 17, wherein the pivot bearing assembly is formed by a dust- and/or liquid-tight roller bearing with one degree of freedom.

20. The torsional vibration damper according to claim 17, wherein a device compensating for an axial offset between the axis of rotation of the primary mass and the central axis of the primary mass receptacle on the housing is arranged between the hollow body forming the primary mass and the housing.

21. The torsional vibration damper according to claim 12, wherein the housing is connected to the housing of the drive engine such that they are fixed to the frame.

22. The torsional vibration damper according to claim 12, wherein centrifugal force pendulums are arranged on the secondary mass and are enclosed together therewith by the hollow body forming the primary mass.

23. The torsional vibration damper according to claim 13, wherein centrifugal force pendulums are arranged on the secondary mass and are enclosed together therewith by the hollow body forming the primary mass.

24. The torsional vibration damper according to claim 14, wherein centrifugal force pendulums are arranged on the secondary mass and are enclosed together therewith by the hollow body forming the primary mass.

25. The torsional vibration damper according to claim 12, wherein the sealing assembly between the hollow body forming the primary mass and the housing is formed by an elastically deformable friction ring.

26. The torsional vibration damper according to claim 13, wherein the sealing assembly between the hollow body forming the primary mass and the housing is formed by an elastically deformable friction ring.

27. The torsional vibration damper according to claim 14, wherein the sealing assembly between the hollow body forming the primary mass and the housing is formed by an elastically deformable friction ring.

28. The torsional vibration damper according to claim 15, wherein the sealing assembly between the hollow body forming the primary mass and the housing is formed by an elastically deformable friction ring.

29. The torsional vibration damper according to claim 12, wherein a pivot bearing assembly is arranged between the hollow body forming the primary mass and the housing.

30. The torsional vibration damper according to claim 13, wherein a pivot bearing assembly is arranged between the hollow body forming the primary mass and the housing.
